(19) United States
(12) Patent Application Publication
(10) Pub. No.: US 2020/0363876 A1
(43) Pub. Date: Nov. 19, 2020

(54) MODULAR SYSTEMS AND METHODS FOR CONSTRUCTING ELECTRONIC INTERFACES

(71) Applicant: Myles CONLEY, Seattle, WA (US)

(72) Inventor: Myles CONLEY, Seattle, WA (US)

(21) Appl. No.: 16/624,770

(22) PCT Filed: Jun. 21, 2018
(86) PCT No.: PCT/US18/38814

§ 371 Date: Dec. 19, 2019

Related U.S. Application Data
(60) Provisional application No. 62/527,716, filed on Jun. 30, 2017.

(51) Int. Cl. G06F 3/02; G06F 3/023; G06F 30/20

(52) U.S. Cl. CPC G06F 3/0216; G06F 3/023; G06F 2111/20; G06F 30/20; G06F 3/0219

(57) ABSTRACT

The disclosure creates ergonomic input devices for computing devices by combining multiple modules. User interface modules are used to aggregate sets of switches or other input sensors or devices for providing feedback to the operator. These interface modules can then be mounted in a position comfortably within the range of motion for a specific part of the body, and oriented for ergonomic advantage while activating the sensor. Collections of interface modules are affixed to a framework or base so as to maintain relative positions. Adapters may be added to adjust the orientation or type of inputs connected to these modules. These interface modules are connected to a parent module that can translate activity for each input sensor on each interface module into a specific set of programmed actions and into input for the computing device.

### CROSS REFERENCE TO RELATED APPLICATIONS

This application claims priority and benefit from the U.S. Provisional Patent Application 62/527,716, filed Jun. 30, 2017 and titled, “Modular System for Constructing Electronic Interfaces,” which are incorporated herein by reference in their entirety for all purposes.

### BACKGROUND

Conventional keyboards for computers, typewriters, or portable electronics typically place substantially all input keys in a single plane, and within one contiguous rectangular shape. The plane of a conventional keyboard may be flat, or angled towards or away from the operator.

A number of ergonomic keyboards have introduced three-dimensional curves to the keyboard, in order to better fit the natural curves described by flexing and contracting the digits of the human hand, including both fingers and thumbs. Other keyboard makers have separated the keyboard into two or more components to allow the user to choose the hand separation distance and orientation. A few have combined these approaches.

Some keyboards permit adding foot pedals or remote switches. Others allow part of the keyboard to be detached, or allow adding and removing mouse or pointer devices. Many keyboards allow re-programming the input to a host computer that follows a given key being pressed.

Simple computer keyboards are constructed with a single switch array and a microcontroller that translates switch events into a protocol understood by the computing device. More complicated or split keyboards may add Integrated Circuit (IC) Input/Output (I/O) expanders to increase the number of inputs available to the keyboard's microcontroller, or to reduce the number of wires required to interconnect separate parts of the keyboard.

Some keyboards are constructed to allow auditory or haptic feedback, such as a solenoid or speaker click when a key is depressed.

Standard computer keyboards may lead typists to use awkward or non-neutral postures. These can lead to a variety of repetitive strain injuries. Ergonomic keyboards allow the typist to assume a more natural position, and may reduce the risk of injury.

### BRIEF DESCRIPTION OF THE DRAWINGS

Non-limiting and non-exhaustive embodiments of the invention are described with reference to the following drawings. In the drawings, like reference numerals refer to like parts throughout the various figures, unless otherwise specified, wherein:

FIG. 1A is a diagram showing logical components of a device.

FIG. 1B illustrates processing steps using these components.

FIG. 2 is a block diagram illustrating system components of the invention.

FIG. 3 is a side perspective view of an interface module.

FIG. 4 is a set of four sample interface modules.

FIG. 5 is a perspective view of an interconnected set of interface modules.

FIG. 6 is a perspective view of an interface module that shows mounting options.

FIG. 7 is a cutaway view of an adapter that allows a switch to be connected to an interface module at a different angle.

FIG. 8 is a diagram of an assembly of interface modules.

FIG. 9 is an input device layout for one embodiment of a ten-key keypad.

FIG. 10 is a side perspective view of a base to hold multiple interface modules.

FIG. 11 is a mapping of the keyboard layout of FIG. 9 to a subset of the modules in FIG. 4.

FIG. 12 is a block diagram of the development process of constructing an input system with notes of potential software and services to facilitate construction.

### DETAILED DESCRIPTION

The disclosed systems and methods permit construction of sophisticated ergonomic input devices that are customized for an operator. The devices are created from standardized modules, each of which contains an integrated circuit processor, One class of module, an “Interface module”, connects a collection of switches or other operator input sensing devices to a processor. This processor is also connected to a signal bearing medium used to communicate with other modules. The Interface module processor translates the activity of the input sensing devices into communications with other modules.

A second class of module, the “Parent module”, is connected to one or more Interface modules by shared communications media. A processor on the Parent module receives input sensor activity information from Interface modules, and sends signals based on this activity to an attached host computer, smart phone or electronic computing device. Both classes of modules may include sensory output devices such as lights, speakers or haptic actuators for providing feedback to the operator, and which may be activated by the local processor based on input sensor events.

Interface modules are affixed to a framework, mount, or base, and positioned so that the sensors or switches on each module are convenient for a specific range of motion of a specific part of the operator's body, and all modules are placed so as to allow the operator to maintain a comfort-able body position.

This range of possible placements and sensor positioning permits constructing input devices to fit a wide range of body types and debilities.

While ergonomic keyboards reduce health risks, the majority of keyboards sold are traditional models that fit within a rectangular plank shape, with keys in a regularly spaced grid. Some factors limit the adoption of ergonomic keyboards include that ergonomic keyboard present the consumer with a higher market price driven by low production volume and difficult assembly. The most contoured and customized keyboards require manual assembly and cost significantly more, and in some examples up to eighty times more, than mass market alternatives.

Keyboard manufacturers commonly produce only a few models of keyboard, which necessarily target physiometric averages rather than accommodating the extremes. Manufacturers have developed shaped Printed Circuit Boards (PCBs) that permit three-dimensional keyboard shapes, but these PCB shapes cannot be customized to a user, or adjusted subsequent to purchase.

These factors are added to the limitations common to standard, non-ergonomic keyboards: (1) in common matrix keyboards, all switches are polled at an equal priority, where the operator may prefer a faster response from specific key; (2) devices that provide feedback to the user after a keystroke can suffer from latency or indeterminate results when the keyboard processor is busy; (2) conventionally assembled keyboards require disassembly or replacement of a substantial majority of the keyboard in order to repair or alter an input switch; and (4) on a traditional matrix based keyboard, each location for a potential switch addition or modification must be planned in the factory. These keyboards do not allow the operator to remove unwanted switches, or to add switches not foreseen by the original manufacturer.

Without the ability to find and test a rare keyboard, or to alter a keyboard's fit after purchase, typists may avoid experimenting with new keyboard designs.

Although others have created ergonomic keyboards and other keyed input devices, various aspects of the disclosed modular systems and method are superior because they: (1) may be assembled, repaired and customized in the field by a non-specialist; (2) permit a wider range of ergonomic configurations, applicable to a wider range of physiological variations; (3) can readily be extended for use with body surfaces other than finger and/or thumb tips, including the palms, feet, or the chin, (4) decrease latency in detecting and responding to switch actions and sensory feedback; (5) permit sensory feedback localized to a digit, input sensor or region of the human body; (6) permit consolidating multiple types of input sensors into one input source for a computer, phone or other computing device; (7) reduce the need to create new PCBs for different models of keyboard; (8) can be used with multiple existing keyboard construction and assembly techniques, and are inter-operable with existing keyboard components; (9) can be constructed with low power, low-featured or inexpensive integrated circuits; and (10) permit prioritizing specific input sensors.

### Components and Processes

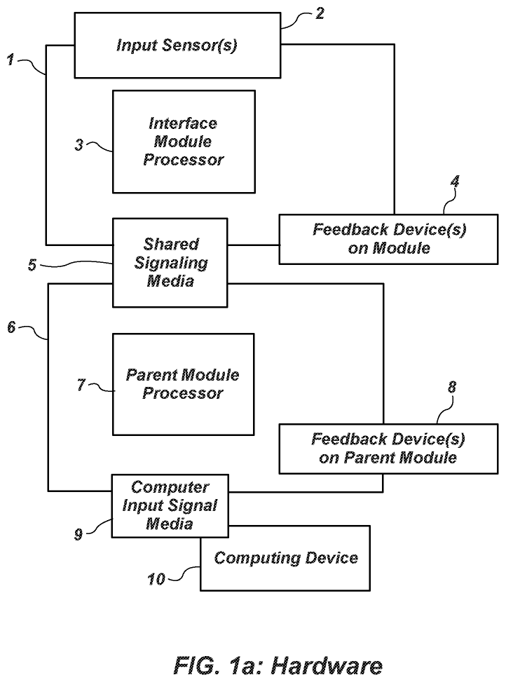

The disclosed methods and systems use a combination of modules to translate activity on keyboard switches or other input sensors to a computing device. The logical components and processes of this invention are described in FIGS. 1a and 1b. In FIG. 1a, an Interface module (1), contains input sensors such as a switch (2), a processor (3), and a connection to a shared media for electronic signaling (5). It may also have local devices for providing feedback to the operator (4). At least one Parent module (6) is connected to the same shared signaling media. The Parent module contains a processor (7), may contain feedback devices (8), and is connected to an electronic computing device (ECD) such as a computer or tablet (10), by means of electronic signal bearing media (9). In operation (FIG. 1b), processes on the interface module processor detect signal input (11), execute local functions such as de-bouncing or analog to digital conversion (12), activate any feedback devices connected to the interface module (14) as determined by previous programming, and communicate with other devices connected via shared media (16). This local processing avoids any delay introduced by communicating with the parent keyboard processor or the computer CPU, and allows local feedback response to closely follow sensor activity.

The parent module executes processes on the parent module processor to exchange data with other devices on the shared communications media (20), execute local functions such as mapping input sensor activity to a keystroke to be sent to the computing device (22), activating feedback devices connected to the parent module (24), and communicate with the computing device (26).

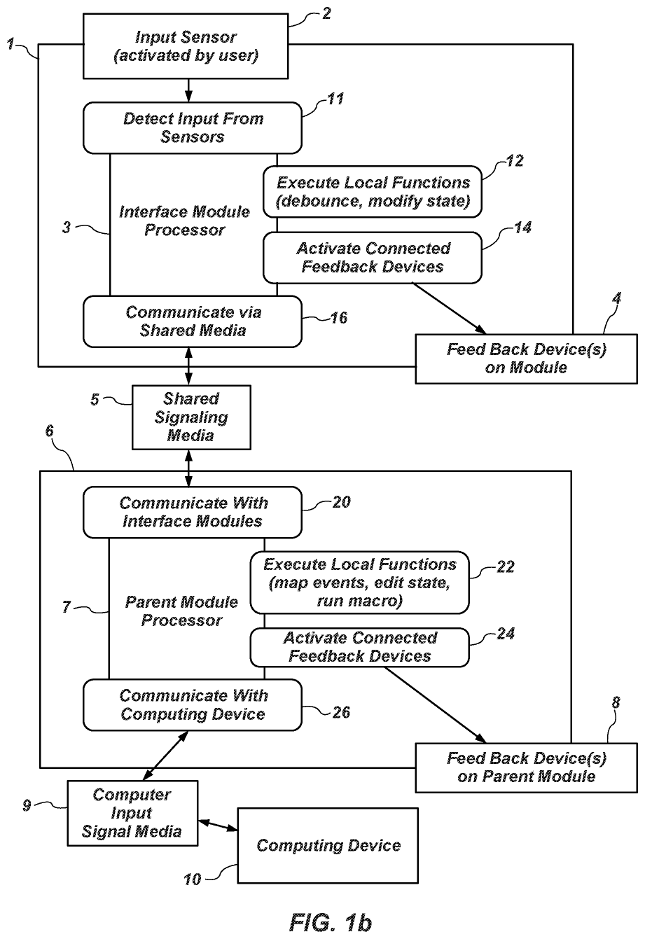

As shown in the block diagram of FIG. 2, this invention permits keyboards or other electronic input devices (62) to be created using an assemblage of one or more sub-component modules (53-57). An electronic computing device (ECD) such as a computer, tablet or phone CPU (50) is connected to the processor on a Parent Module (52) by means of a standard input protocol and associated physical media (51), such as USB, Bluetooth or i2c. The processor of the parent device (52) uses one or more shared signal bearing media (61a) to communicate with to one or more interface modules (53, 54) using electronic communication protocols and associated physical media such as SPI, i2C, TWI, 1-wire, serial data, etc. The parent module processor (52) may also communicate with modules connected to a secondary shared signaling media (63) through a aggregating child device (60) that shares signal bearing communications media with one or more interface modules (55,56,57).

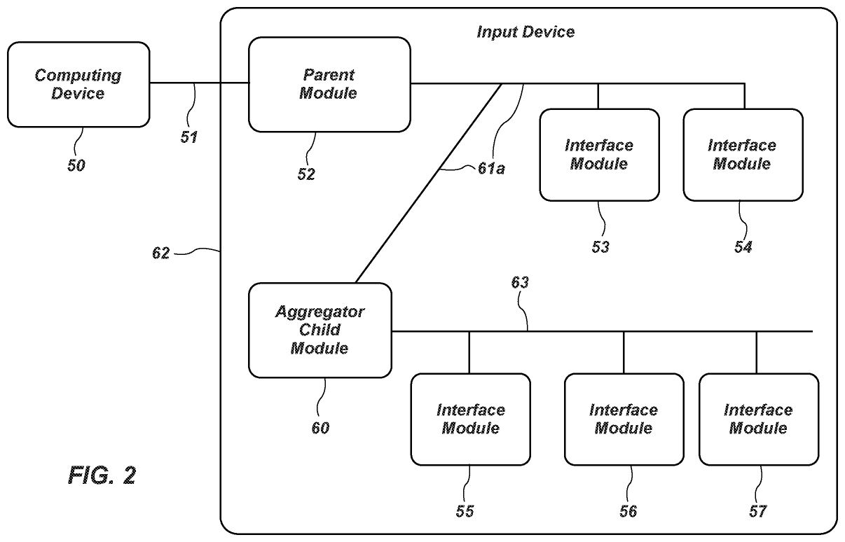

In the perspective drawing of FIG. 3, an Interface module has a Printed Circuit Board (PCB) (108) populated with a dedicated processor (114). The processor is connected to the Parent module and other Interface modules through connectors to shared signal bearing media (102 and 104). The Interface module processor is electrically connected (112) to one or more input sensors, such as mechanical switches, capacitive sensors, or other sensors capable of registering operator actions (100a, 100b, 100c).

For ease of construction, Interface module PCBs may be modular so that unwanted components may be removed. In one embodiment, modules may ship with perforations to allow half of the PCB to be removed. In one embodiment, detached sections of the PCB may be electrically reattached with jumper connections, for example, between the original and detached sections of the Interface module.

An interface module may contain output devices for haptic, visual or auditory feedback. These output devices may be per input device, as illustrated by LEDs (106) underneath switches (100a-c) or per module as illustrated by piezo speaker (110).

In operation, the operator activates switches or other types of input sensor through the motion of the operator's body. The operator's comfort is influenced both by the surface of the body used to actuate a sensor (the Contact Surface), and by the path the body must describe to activate the sensor.

The contact surface may be any outward surface of the operator's body capable of propelling a mechanical interface along an axis, or of activating an electronic sensor. Possible contact surfaces include (but are not limited to), the palm of the hand, the heel of a foot, the top, side or pad of a digit, etc. Where a body part can move on multiple axes (as in the thrusting, opening, and side to side movement of the jaw), one or more modules could be assigned to each independent axial movement, with sensors on each module placed for comfortable interaction with the applicable contact surface of the operator at that point in the operator's range of motion. Contact surfaces need not touch the input sensor, as any observable activity of the contact surface may be used by an input sensor. This includes measurable emission, absorption or reflecting of radiation from the contact surface, changes in sound, heat or displacement of air by the contact surface, changes in humidity, conductivity or texture of the contact surface, and any change in mechanical force transmitted through the contact surface.

Dedicating modules to a contact surface of the operator can be used to improve feedback to the operator. In one embodiment, for a contact surface of the tip of an operator's index finger, the interface module would be aligned under the path the operator's finger follows in front-back extension. Since the specific contact surface, in this case a specific fingertip, can only be in one location at a time, one haptic or audio feedback device on the module PCB is sufficient to provide rapid, distinct and local feedback for all operator actions by that digit within the selected range. Each module may be programmed with a distinctive pattern of feedback, so that in one example, the auditory tone played when an index finger depresses a switch is lower than the tone played when the smallest finger depresses a switch. Fingers are defined as all digits on the human hand, which for sake of clarity includes both fingers and thumbs, and may include portions of digits, such as one or more phalanges in the hand digits. Toes are defined as all digits on the human foot or portions of the phalanges in the human foot.

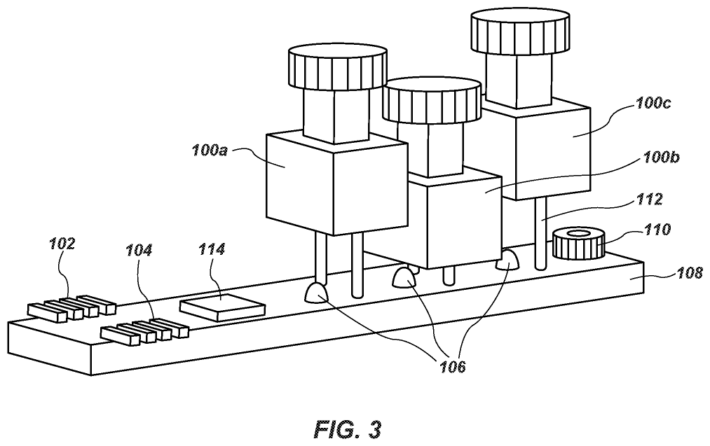

To accommodate the physiological range of the intended operator(s), one input device may require multiple shapes or conformations of Interface modules. FIG. 4. is a projected view of several possible designs for interface modules. Each has a processor (410a-d) and some number of possible switch locations (420,421,422). In one embodiment, the linear PCB shape (401) may be used for all finger or thumb digits, while a radial or wedge shaped PCB (404) would be used for either thumb. Spacing between switches may vary to accommodate different keycap sizes, such as the size difference between alphanumeric keys and the Enter key, as shown by the different spacings between objects 420,421, on modules 401 and 402) for example.

Object (403) depicts a minimal Parent module with connections to a computing device (412) and a processor to communicate with interface modules (410c). The Parent processor may be built into an interface module, so that in one embodiment, a single PCB hosts input sensors, feedback modules, a connection to the PC or electronic computing device host, and a signal media connection to other modules.

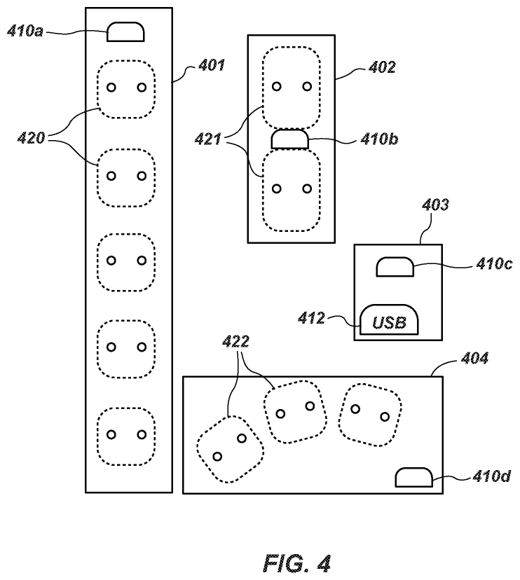

FIG. 5 is a perspective view of six Interface modules (506, 514, 518, 522, 524, 526) arranged for a right handed user. Each module has a local processor (516), and all modules are connected by a common signal bearing communications media (510) with one end of the media (504) available for connecting to a parent module. FIG. 5 illustrates how modules can be arranged for ergonomic advantage. For most people, the middle finger is substantially longer so the central module (522) is placed lowest. Modules on either side (518,524) are raised to meet the second/index finger and the third/ring finger. Assuming the operator's ring finger is shorter than the index, the corresponding module (524) is both elevated and shifted towards the operator. Some people find it easier to extend the smallest/pinky finger away from the third finger than to extend it forwards. The module for the little finger (526) is shown rotated and elevated to match this group's preferred finger path.

Unlike flat keyboards, or keyboards that use linkages to connect switches to keycaps, using interface modules permits switches to be placed at an angle that allows force to be transmitted from the body surface of the operator directly through the central axis of the switch. A combination of modules may be placed to allow a digit to press switches with different contact surfaces for different angles of force. In FIG. 5, Module 518 is positioned in the traditional location for an index finger with key 502 positioned for a downward press of the finger. The leftmost Module (514) is angled and elevated to allow the edge of the operator's index finger to deflect key 512 along the switch axis. The rearmost module (506) is positioned for switches to be pushed by a forward movement of the operator's nail and fingertip with switch 500 positioned to be pressed by the operator's index finger. Other positions are possible, moving each module on the right-left, up-down, or forward-backward axis, or by rotating the module around any of these axes.

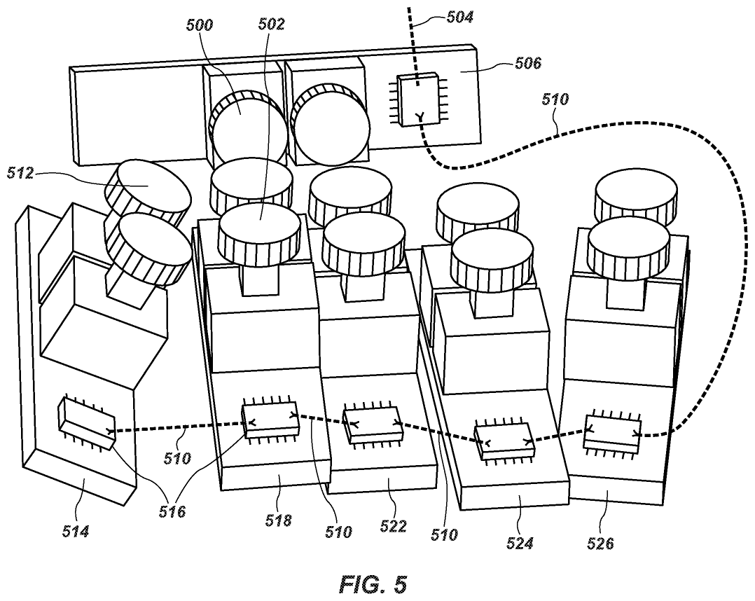

The perspective illustration of FIG. 6 shows how switches and other input devices connected to an interface module may be further customized using adapter modules (607,604). These modules allow switches (601,602,603) to be placed at different heights and angles in respect to the module PCB (606). This in turn allows input devices or keycaps to be placed in configurations that follow the arcs naturally described by a body part. An input device creator can start with a known arc, and known properties of a switch, and determine the angles and heights that would best allow the arc. Multiple adapters may be stacked or used together to attain the desired conformation. Adapters may also be used to reduce interference between switches and connections to shared signal bearing communications media (605).

Switches and other keyboard input sensors are generally installed in a grid, which means any translation of one switch will cause neighboring switches to intersect, or that the moved switch may be unable to connect to pre-defined mounting points on a PCB. Adapter modules allow a new non-intersecting three-dimensional matrix to be constructed that is connected back to the two dimensional matrix of the interface module PCBs.

Adapters may also allow the use of switches or sensors that are not compatible with the base PCB. In FIG. 6, adapter module 607 is used to permit a different kind of switch device (601) to be placed in ergonomic proximity to other switches used in the device (602, 603). By using adapters, multiple brands or types of input sensors may be used in one Interface module. In FIG. 6, objects 602 and 603 may represent electromechanical and/or mechanical switches, while 601 represents an ultrasonic range detecting sensor. Adapter 604 may simply adjust the curve a finger travels between switch 602 and 603. Adapter 607 may serve multiple purposes, adjusting input device 601 for ergonomic purpose, altering the offset of the leads to match the local grid, and adapting the three connector physical package of 601 to the two connector positions on PCB 606. Passive, active and electromechanical components may be placed within the adapter to adapt the power, electrical properties or digital signal of 601 to a format compatible with processor 605. Where this adaptation is not possible, a separate interface module may be used, that is capable of interfacing with the desired input sensor. Finally, an adapter may allow a solderless, field replaceable switch interface to be matched to a PCB that requires fixed or soldered connections.

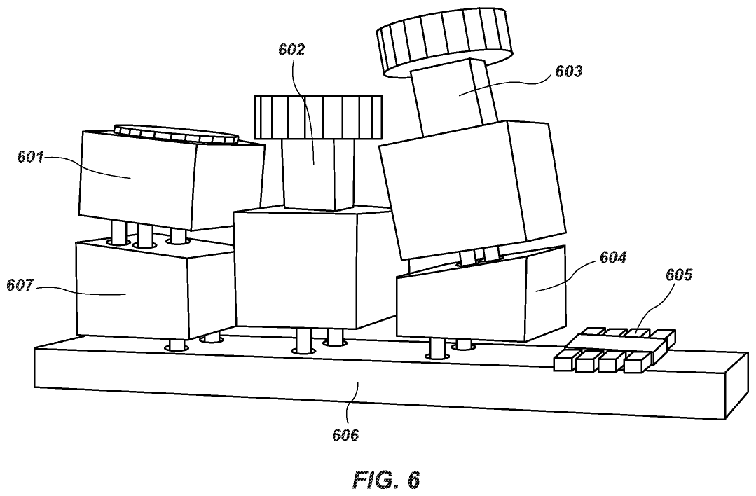

FIG. 7 shows a cutaway view of height and angle adapter for connecting an input sensor to an interface module. The body of an input sensor height and angle adapter (701) is created to receive a switch on the top surface, and to present the same profile to a PCB on the bottom. In this example, a cutaway depression on the top (704) is matched by a protuberance (706) on the bottom. Electrical connection is maintained and extended by connecting sockets on the top (708) to lead extensions on the bottom (702).

The combination of module placement and per-sensor height and angle adapters can be used to better match to the operator's comfortable range of motion. As an example, consider an operator who has had one or more phalanges of the index finger amputated. To overcome the distance in reach between the index and middle finger, the index finger interface module is elevated above that used for the middle finger. The center of the finger's range of motion shifts towards the body, and so the center of the interface module may likewise shift towards the body. The amputation also decreases the radius of the curve described by curling and extending the finger. Adapter modules are chosen to elevate keys in the rows below and above the home row, and may rotate the switches to better face the arc of the index finger. Depending on the amputation and how many of rows of switches are desired, at some point the contact surface for a row changes from the surface used for a downward motion to that used for a poking or inward-curling motion. When a height and rotation adapter cannot place a switch or sensor at the correct location to receive a poking or curling motion, an additional interface module can be added in that location.

### Communications Between Modules

Interface modules must communicate information about the activity of attached input sensors to the Parent module processor. This information may either be in the form of sensor state data, which describes the current position or value of a given input sensor, or in the form of a coded value shared between the Interface and Parent modules. Sensor state data depends on the type of sensor. The traditional electromechanical keyboard switch produces binary outputs, such as on-off, Boolean outputs, for example. Other types of mechanical travel, distance, or directional sensors may produce a range of values that correspond to the position of a reference point between determined maximum and minimum values. For example, electronic sensors, such as a temperature sensor, may have no moving component but can still receive input from the operator, such as by breathing on the heat sensor, for example.

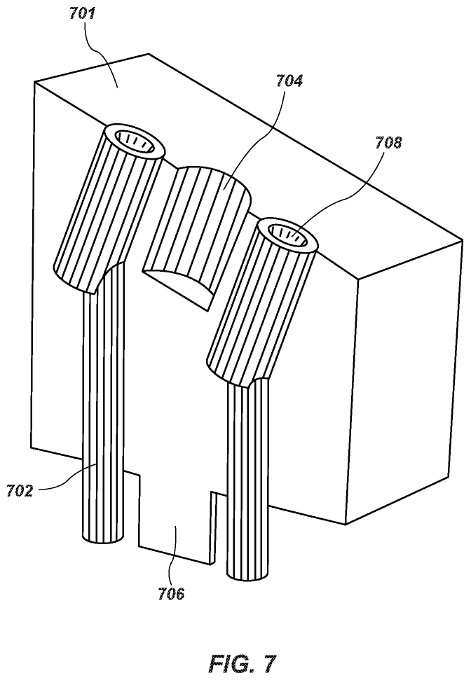

Within each mounting structure, all interface modules are electrically connected using one or more signal bearing communications medium. FIG. 8 shows 5 interface modules (812, 814, 816, 818 and 820) connected to a Parent MCU board (810) that possesses a connection to the a computing device (825). For coded communications, interface modules may be configured to map each input sensor action to a letter, scancode or similar identifier that the Parent module can map directly to a local activity or an output for the computing device.

Interface modules may be configured to uniquely identify input sensors. First, each Interface module may be configured so that the Parent Module processor can uniquely identify it, i.e., the interface module is discrete from the other interface modules. In the example embodiment illustrated in FIG. 8, each interface module has a unique identifier programmed into the local module processor, (marked as id 1, id 2, id 9, id 5, id 6). The parent may also have an identifier unique to the medium, (marked as idP). In this example, the interface module may fitted with a series of on-off switches in a specified arrangement (marked as positions A-E). The state of these switches can then be communicated to the Parent module as a series of five bits, with the least significant bit corresponding to the bottom position (E), the most significant to the topmost (A), and the middle switches assigned correspondingly incremented positions. Instead of sending five (5) bits mapped to five (5) switches, the interface module could send a series of sensor state readings in a specified order, or prefix each sensor's data with a unique identifier. This protocol information may be standardized for all modules in an input device, unique to each class of module or individual interface module, or use a combination of techniques. In each case, the Parent processor must be programmed to detect and apply the correct protocol for each Interface module.

In one embodiment, the manufacturer may distribute collections of modules with non-overlapping IDs, and human readable indicators of each module's identifier. Alternately, the constructor may modify the module identifier by programming the module processor or setting an address by means of a hardware setting such as a jumper, solder pad, or dip switch. Alternately, the parent processor may calculate unique identifiers for each module, based on electrical or positional properties of the module. In one implementation, these module identifiers may be used by the Parent module to map modules to a list of communications protocols or a map of module switch identifiers to physical locations on the module.

The same communications medium may be extended between multiple, physically separated components of the input device. In FIG. 8, objects 822a-c are used to illustrate a shared signaling medium connecting the modules. The topology and media for these interconnections may be selected for mechanical reasons, such as the need to connect multiple nodes in a constrained space. Different communications media may be used in different sections or physical components of the design. In one implementation, a 12 wire bus may be used inside both a keyboard housing and a foot pedal, and wireless radio links may be used for the connection between these components. In one implementation, power may be distributed over the signal media, creating an electronic bus. Modules may be connected to multiple communications media, with the media selected based on criteria such as speed, latency, type, or priority of traffic.

In one implementation, at least one of the communications media may also be used for programming interface modules.

### Standard Operation

In daily operation, the operator connects the input device to a PC, Tablet or other electronic computing device. Upon power-up, the Parent module of the input device begins communicating with all Interface modules, either by polling or by waiting for updates from the modules. When the operator depresses a key or interacts with a sensor, the processor on the corresponding interface board detects the sensor change. The processor may take local action, such as debouncing the event, and may change the state of local feedback devices such as LEDs or buzzers. If programmed to do so, the processor also sends data to the Parent processor, which in turn communicates with the computing device. The Parent processor may also receive updates from the computing device CPU (e.g. a request to update a caps lock switch state LED), and route them to the relevant interface module, optionally including an instruction to update the state of an output device. The Parent processor may also communicate with interface module processors in order to access storage or processing capacity on their processors or to update module feedback devices. The parent processor may be configured to alter the order in which data may be recovered from Interface modules, so as to prioritize polling certain input sensors. In one implementation, the Parent processor may track the frequency of event data from each module in order to dynamically re-prioritize traffic, if desired.

### Construction of an Input Device

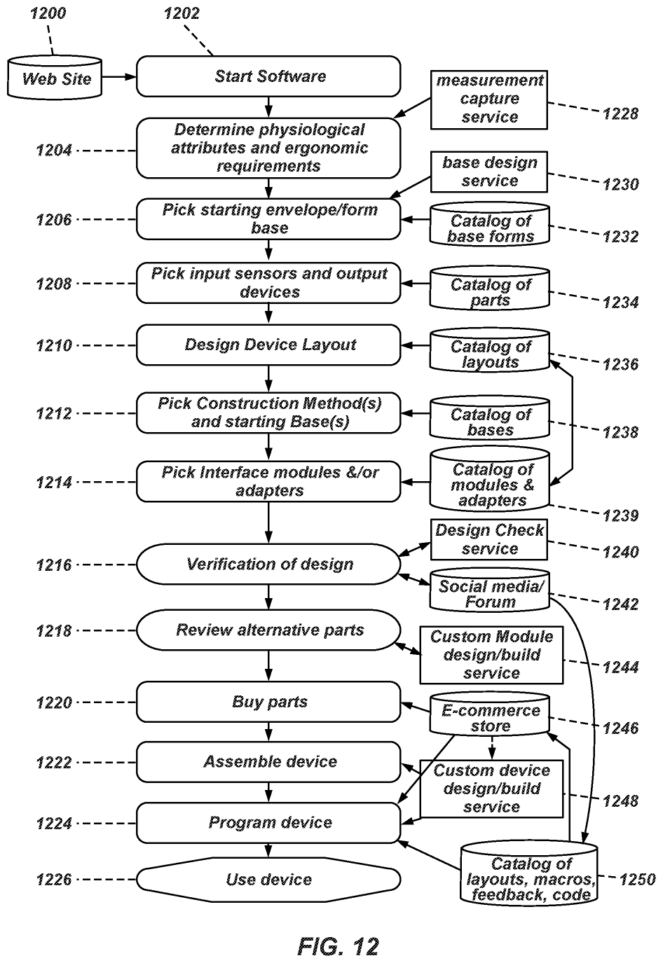

To create an ergonomic input device, Input modules are affixed to one or more mounting frames, structures or bases that allows the relative position of modules to remain constant. These structures may be designed or selected to permit further ergonomic adjustment by the constructor or the operator of the device. In one embodiment illustrated in FIG. 12, construction software (1202) helps the constructor to design and procure their input device. This software may originate from a website (1200) or any other user access point.

The constructor may start with the ergonomic requirements of the operator and work towards an ergonomic layout. In this case, they may obtain a set of ergonomic measurements or requirements for the device operator (1204), possibly using an automated service or human professional (1228) in some examples. The captured measurements may include, but are not limited to: the desired pronation of the operator's wrist; the desired front-back inclination of the input device; the desired inclinations of the operator's hands and forearms; the desired spacing between the operators hands; the desired spacing between the operator's forearms; the desired relative spacing between the operators limbs, such as the distance between a switch activated by the top of the left knee and a switch operated by the left middle finger; the desired rotation of the operator's finger tips around the middle fingers. The rotation of the operator's finger tips around the middle fingers can be described as the angles between a line described by connecting the operator's shoulders and a line described by connecting the distal phalanges of the index and smallest finger on one hand. In one implementation, the design for the relative placement of input sensors considers the assignment of keys to a specific contact surface of the operator, such as a finger pad, the comfortable path of that contact surface between input sensors, and the desired orientation of each key for most comfortable and ergonomically advantageous access by the operator.

Continuing the example, the constructor selects a base envelope or “blank” and customization technique for this input device (1206). For example, the constructor may start with the idea of a keyboard split into two board shaped sections to be milled out of wood or another material or combination of materials, as needed or desired. The combination of blank and customization technique is chosen to meet primary ergonomic goals, and to permit later modification. The constructor may be connected to a service to design new blanks (1230), or provided a catalog of existing forms (1232).

In our example, the operator selects the input sensors and feedback devices that are used for the device (1208), possibly from a determined catalog of parts (1234) if one is provided. This part selection constrains the possible types of layout and construction although in alternative examples no constraints are included in the part selection.

At this point, the constructor selects a layout (1210), a mechanical design for the placement, number and orientations of the switches, input sensors, and feedback devices used in an input device. They may also start with a common input device layout such as the “enhanced” 101 key IBM® PC/AT keyboard layout, the ANSI-INCITS 154-1988 keyboard layout, for example, or the 4×3 matrix of the telephone keypad. These are frequently modified to new designs, such as the “60%” reduced ANSI keyboard that is found on Apple® notebooks sold in the United States. Device layout need not be limited to a contiguous shape or a single plane. For one embodiment, the constructor could envision a set of 5 units, one for each foot, one for each hand, and one for the head. Each would have a set of sensors, feedback devices and device positioning appropriate for that part of the body. In the example where software is used to facilitate construction, the user may pick from an existing catalog of layouts (1236).

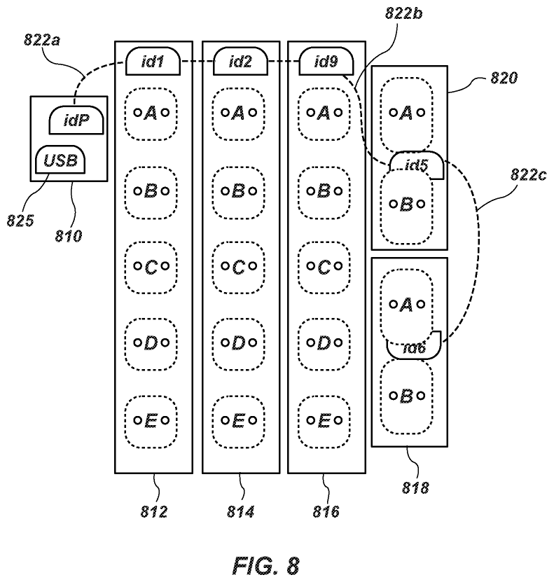

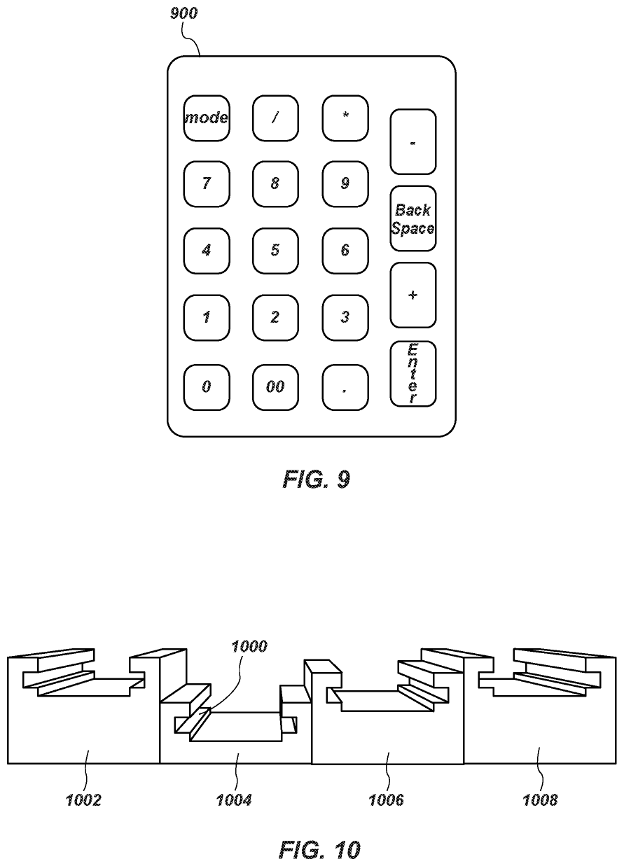

FIG. 9, object 900 shows an example design, representing the common 10 key data entry keypad. The layout design may be determined by commercial factors, such as available key-cap sizes, or by aesthetic, economic, space or topology constraints, ergonomic theory, population measurements, or measurements of a specific individual. For example, if the constructor's primary ergonomic goal is to create a contoured keyboard that conforms to the average shape of the human hand, the operator may choose a blank of milled slots as shown in FIG. 10. This shows a perspective view of one assemblage for mounting interface modules. In this example, four shapes of varying height (1002, 1004, 1006, 1008) are milled (1000) to hold an array of interface modules at a relative heights, spacing, rotation, etc. that is desired by the operator.

In the example of FIG. 10, the operator can further customize the front-back position of the keys, and the up/down axis could also be modified by replacing milled sections. In contrast, an embodiment that fixed all interface boards in a static position by casting an entire unit out of resin would prevent any later adjustment by the operator. Casting might be ideal for a foot pedal implementation, where the later ergonomic adjustments could be made by adjusting screw jacks on the bottom of the shape.

Each construction technique introduces limits on how interface modules may be placed. For example, gluing modules in parallel to a planar surface prohibits rotating the modules around the front-back axis. For this reason, one input device is likely to use multiple construction techniques. In the example from FIG. 10 above, the constructor may choose a cast shape for setting default heights and inclinations, and mechanically attach milled T-slots for front-back adjustability.

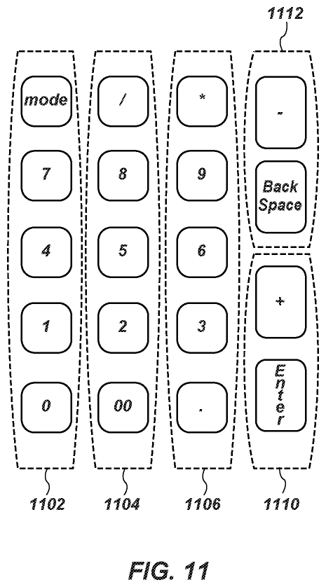

In one embodiment (FIG. 12), the constructor may use software to select of pre-made blank and construction methods (1212) from a catalog of starting bases (1238) using a catalog of starting bases (1238) for solving specific mechanical problems, such as the casting shape that sets default heights in the example above. Next, the constructor picks Interface Modules (1214), possibly from a catalog of available module shapes (FIG. 4), (1239), so that the combination of modules provides the input sensors and alignment of the desired keyboard layout. FIG. 11 illustrates a logical grouping of Interface modules that matches the desired layout of FIG. 9. In this example, three five-position Interface modules (1102, 1104, 1106) are combined with two two-position modules (1110, 1112) to attain the desired logical layout.

Developing the mapping between layout and modules is simplified if the constructor starts by arranging existing Interface modules. In one embodiment, this calculation is done with the aid of computer software, providing a computer aided design tool to pick modules, sensors and feedback devices from a library and place them in desired locations. The software verifies that each sensor and feedback device's location fits within the design requirements of the chosen base envelope and construction technique. After verifying a design, the software may allow the constructor to order required parts.

In one embodiment, constructors may use software to create a desired input device layout selecting input and feedback devices and their locations. They may then use the software to pick interface module shapes drawn from a catalog of available Interface modules shapes, (e.g. FIG. 4), and place them over sections of the layout design. The software verifies that each sensor and feedback device's location is acceptably close to the desired device layout may interact with the constructor to resolve conflicts (1216), or connect the constructor to a design and construction service (1240), or social media forum (1242). The software may also provide a catalog of module combinations determined to match common layouts.

In another embodiment, the constructor creates a desired input device layout using layout software, and then uses automated software to search for a collection of modules that match the constructor's design. Solving criteria may include: price, availability, the ability to connect to all sensors and feedback locations, wiring interconnections and the space needed to route between modules, ease of assembly, electrical considerations such as power and Radio Frequency Interference (RFI), structural concerns such as flexibility or rigidity, etc. Where a match is not possible, the software may suggest alterations. The software may also suggest additional PCB shapes or adapter modules that allow assembly of the constructor's design, and may connect the constructor with an online store or marketplace for purchasing these additional modules.

In another embodiment, the software may start with a model of the operator's physiognomy or a 3 dimensional model of the desired switch locations. The software may then seek the minimum total number of interface modules, such that: (1) all switches or sensors are assigned to an interface module; (2) the number of assigned inputs and outputs for each PCB is within the range provided by that PCB; (3) the front-back and left-right spacing between any two switches are acceptably close to that specified in the device design; (4) no parts of the interface modules intersect; and (5) all modules may be mounted using the chosen base framework.

During the design process, the designer or software considers the following constraints:

1. for input or feedback devices at different elevations to share a module, their up-down spacing must be substantially the same, or within reach of an adapter or connector that can connect the input or feedback device to the PCB.

2. for input or feedback devices at different rotations to share a module, the rotation must be within the range that can be accommodated by the sensor leads or an adapter between the sensor and the interface module PCB.

3. when sensory feedback devices are used, and it is desirable to share feedback for a given contact surface of the operator, all switches activated by the same operator contact surface should use the same module.

If the desired arrangement is not possible with a given set of modules, the software may suggest different parts or adjustment adapters and may allow the constructor to purchase these adapters from an online marketplace (1220). The software may also suggest new PCB shapes for modules that allows assembly of the constructor's design (1218) and connects the constructor to a service for creating new modules (1244).

The constructor then customizes the base envelope of the input device, altering the framework, base or structure so that the interface boards can be held in the necessary orientation and relative positions. In one embodiment, the software provides blueprints, Computer Aided Design, customization steps or 3D printing files to the constructor, as an output of the computer software, or from an online marketplace.

In one embodiment, the software may allow the operator to purchase interface modules from an online store (1246). Part of the ordering process may include selecting unique IDs for each module, so that IDs match the desired assembly pattern. For example, interfaces in a 4 column design would have IDs 1 through 4 programmed in at the factory or retailer and labeled for ease of assembly. This step simplifies mapping the physical layout to the logical, especially if information from the device construction software is passed to the software used to create this mapping.

During assembly (1222), the constructor electrically connects all interface modules to one or more communications media (FIG. 8, 822) shared with the Parent module processor, or a child aggregator module. The constructor may choose to have the device constructed for them by a service (1248).

Before or after assembly, the constructor programs each interface module with any desired behavior that remains local to the module (1224). This may include patterns of sensory feedback (such as notes, tones, or lighting patterns), or complex local behavior such as actions that depend on the timing of keypresses or combinations of local keys. This programming may be instantiated by using local hardware settings such as dip switches, solder pads or jumpers to choose between pre-programmed behavior, by modifying electronic storage such as flash storage, or other electronic configuration settings on the device, or by re-programming the module processor. In one embodiment, this programming is done at the factory or retailer based on configuration settings from the creator's design software. Local or web based software may make use of a public directory of input device configurations (1250).

Prior to operation, the constructor or operator programs the parent device to map data representing one or more input sensor states for each sensor on each interface module to one or more desired actions. Using the design goal of FIG. 9 and the construction of FIG. 8 as an example, object 812 is the Interface module with id 1. In this example, when the parent module receives information that the switch at module 1, location B has been pressed, this is mapped to the action of sending keystroke “7” to the computing device.

In one implementation, the constructor uses a computer program to associate the unique IDs for each installed module with the modules virtually presented in the device layout software. These values may also be pre-populated as part of the purchasing process. The software may connect to the Parent processor and guide the constructor through the process of verifying the location of each module. The software then works with the constructor to map each physical device to a logical location on a specific interface board. In this example, the physical switch in the upper-right-most switch in FIG. 8 is mapped to interface board 5 (id5), input location A.

Once the mapping of physical modules to logical locations is complete, the computer program allows the operator or constructor to associate specific actions with each switch press or sensor activity. Potential actions may include sending a keystroke or Human Interface Device (HID) event to the host computer, running a task local to the parent MCU (such as switching desired keyboard mappings between those used for Microsoft or Apple computers), or modifying settings in the device. To meet the design of FIG. 9, in FIG. 8, the logical switch of id5, location A would be mapped to the event ‘send keystroke “-” to the host CPU’.

Any keystroke customization technique available to a standard microcontroller based keyboard is implementable within this design, including function keys and dynamic remapping between layouts such as QWERTY and Dvorak. In the worked example of FIG. 9, the Mode key in the upper left (Module 1, position A) might alter all keyboard mappings for numbers, so that the effective layout matched that of telephone keypads rather than that used in PC keyboards, or it might change all haptic feedback signals for the device.

The constructor may also specify actions that modify the state of one or more feedback devices on interface modules. Feedback actions may overwrite, modify, or defer to feedback patterns programmed into Interface modules. In one embodiment, pressing the key mapped to Capslock could cause all feedback LEDs across the device to turn red except for switches currently being pressed which would turn white according to a default programming for these Interface modules. With programming complete, the device may be used (1226).

### Alternative Embodiments

The mapping between activity of an input sensor and the events sent to the computing device may be stored on the Parent processor solely, or within the Interface modules solely, or a combination of storage and processing on the two types of module.

When an Interface module sends information pre-computed on the interface module to a Parent or aggregating module, transmitting unique identifiers for the module or sensor location may be optional. For example, position A on module 1 may cause the letter “A” to be sent to the parent device. Upon receipt, the parent module would translate this into the corresponding USB or Bluetooth HID event required to send the letter “A” to the computing device. Identification of the source switch and module is optional if does not matter which input caused the letter “A” to be sent. Having the interface modules compute the output avoids the need for the parent module to know the physical orientation of input sensors on a module, the type or class of the module, or to store a mapping of input sensors to output for the computing device. The pre-computed coding strategy may be used in combination with addressed communications, so that in one embodiment, module identifiers are used to update programming and feedback devices, but keystroke information is sent from the interface modules without source information.

Interface modules may be built with any combination of input sensors, feedback devices, local processors, and parent processors suitable for communicating with a host computer. Possible connection media between the interface modules include round wire, radio link, ribbon cable, optical connections and flexible circuitry. Both the interface module and connection media may be constructed upon the same flexible circuitry, so that a length of interface modules may be cut from a spool.

Interface modules may be programmed to act exclusively for operator input or output, overriding local hardware. Rather than using separable angle, height or sensor type adapters, these height or angle adjustments may be built into the module's printed circuit board, so that the PCB describes a three-dimensional shape rather than the traditional plane. Interface modules may be constructed of a flexible or deformable material, so that the module can be bent to better match a specific range of motion.

Height, angle or type adapters may include internal circuitry to permit one type of sensor or output device to appear as a different type of sensor or output to the Interface module PCB. In one embodiment, an adapter would alter the output of a laser distance meter to appear as an on/off switch to the local processor. Adapters may be made of perforated or otherwise ablatable material, so that the user can create new shapes by removing material, rather than stacking adapters.

Many traditional mechanical keyboards are assembled by slotting switches into a switch plate: a solid plate pierced with holes that mate with clips or threads molded into the body of the switch. Each switch's electrical leads are allowed to pass through the switch plate to a PCB below. Interface module PCBs are compatible with this technique. Switches may be slotted, screwed or otherwise affixed to a pierced plate, and then the electrical leads connected to an interface module PCB below using solder or solderless connectors.

Interface module PCBs may also be used without a switch plate, allowing the modules to be directly affixed to a structure. Potential construction techniques include attaching the modules to mounting points on: (1) the inner or outer surface of a hollow keyboard shell; (2) a solid shape milled, extruded or otherwise fabricated to hold modules in a desired orientation; (3) the joints, unions or shafts of a skeletal framework by means of clamps, screws or other fasteners (as used in chemistry bench structures and stage lighting rigs); (4) a set of flat cut out shapes that can be stacked, slotted or fastened together to make the desired three-dimensional shape; (5) a plane-based framework with markings or pre-made mounting points that may be used in conjunction with a set of regular shapes that contain matching external or internal mounting points, so that arbitrary configurations may be constructed by affixing regular shapes to each other and the base plane (common to machinist/welding tables and interlocking toy bricks); (6) nodes on series of adjustable screws, jacks or gears that permit changing the elevation and angles of mount point for a module; (7) a textile or non-woven structure that may be altered by stretching or folding, with sewn, woven, glued or inked connections; (8) a shape that can be altered by milling or other extractive machining; and (9) a shape that can be altered through additive machining such as CNC welding or 3d printing.

Other methods for setting per-module identifiers include: using a unique system identifier pre-programmed into the module processor, electrical properties of connection bus, properties of the digital signal path between Parent and Interface modules, a dedicated or wired connection between modules, an identifier chosen by a dynamic election protocol, a calculation performed on each module processor.

What is claimed is:

1. An input device for an electronic computing device, comprising:
one or more electronic signal bearing communications media;
one or more input sensors;
two or more interface modules, each interface module including:
interface module processing circuitry electrically connected to one or more of the communications media and to one or more of the input sensors, the processing circuitry configured to:
uniquely identify the one or more input sensors connected to the interface module, and
obtain sensor state data from each of the one or more connected input sensors, and
generate uniquely identified sensor state data for each input sensor from which the sensor state data is obtained, and
communicate the uniquely identified sensor state data to other devices connected to the one or more communications media; and
at least one parent module possessing a parent module processor configured to aggregate input sensor state data from the interface modules, and to send input events based on the sensor state data to the electronic computing device.

2. The input device of claim 1, where the structural arrangement of one or more of said interface modules are based on the shape described by the path an operator's limb, digit, extremity or other contact surface will follow when moved between two points inside the total range of motion for said limb, digit, extremity or contact surface.

3. The device of claim 1, where two or more subsets of said input sensors are physically adjacent to each other, but differ in position or orientation in relation to the operator, and at least one interface module is used for connecting to each subset of adjacent input sensors that share similar orientations or positional relationships to the operator.

4. The device of claim 1, where multiple input sensors are to be placed contiguously, with subset A of one type of input sensor and subset B of a different type of input sensors, and one or more interface modules are used to connect the like sensors of subset A or of Subset B.

5. The device of claim 1, where the interface module processor of one or more interface modules are configured to uniquely identify the interface module to devices on connected communications media.

6. The device of claim 1, where the electronic circuitry of one or more interface modules is configured to uniquely identify the interface modules to devices on connected communications media.

7. The device of claim 2, where the structural arrangement of each interface module is further chosen to permit interconnection with adjacent modules.

8. The ergonomic input device of claim 3, where the structural arrangement of each interface module is further chosen to permit interconnection with adjacent modules.

9. The device of claim 4, where the structural arrangement of each interface module is further chosen to permit interconnection with adjacent modules.

10. The device of claim 1, wherein the one or more input sensors include both an input sensor configured to produce binary output and an input sensor configured to generate a range of values.

11. The device of claim 10, wherein the interface module processor is configured to convert output from both the input sensor configured to produce binary output and the input sensor configured to generate an output with a range of values into output received by the at least one parent module, the at least one parent module configured to interpret the converted output as switch input events.

12. The device of claim 1, wherein at least one of the two or more interface modules is employed for each contact surface of the operator that is used for operator input.

13. The device of claim 12, wherein the contact surface of the operator includes one or more of:
a surface of one or more digits of a hand of the operator that is not on a terminal distal extremity of the digit;
a surface of one or more of a foot of the operator that is not a ball of the foot; or
a surface of the operator that is not a digit on the hand or on the foot of the operator.

14. The device of claim 1, wherein one or more discrete interface modules are employed for each of at least half of the contact surfaces of the operator that are used for operator input.

15. The device of claim 1, wherein one or more discrete interface modules are employed for more than 40% of the contact surfaces of the operator that are used for operator input.

16. A method for constructing input devices for electronic computing devices by assembling modular components, the method comprising:
selecting one or more contact surfaces, the contact surfaces being surfaces of an operator's body that can be positioned and moved so as to temporarily activate input sensors;
selecting two or more modular “Interface” assemblies, where said modules have a determined structure, including, at a minimum, elements for connecting to input sensors, and elements for connecting to one or more communications medium, and a processor configured to obtain state information from connected input sensors and to send data through one or more connected communications medium;
fixing the selected interface modules in a determined relationship placed so that the selected contact surfaces ergonomically activate input sensors connected to the selected modules;
connecting each of the interface modules to at least one communication medium, so that each of the selected interface modules shares a communications medium with at least one other module,
connecting at least one of the communications media previously connected to at least one interface module to a module that has an element for connecting to the inputs of an electronic computing device and a processor element capable of aggregating sensor state data from one or more interface modules and of sending data to the inputs of the connected electronic computing device.

17. The method of claim 16, where at least one component module has a location and connectors configured for later addition of an element for connecting to the inputs of an electronic communications device.

18. The method of claim 16, where at least one component module has a location and connectors configured for later addition of a processor element.

19. The method of claim 16, where at least one component module is chosen and located in order to permit later addition of additional modules through a shared communications medium.

20. An input device for an electronic computing device, comprising:
one or more electronic signal bearing communications media;
one or more input sensors;
three or more interface modules, each of the interface modules including:
an electronic storage component, and
interface-module processing circuitry electrically connected to one or more of the communications media and to one or more of the input sensors, the processing circuitry configured:
to obtain sensor state data from each of the one or more connected input sensors, and
when the sensor state data for one or more identified input sensors matches a determined pattern,
map the pattern of sensor state data to a determined output retrieved from the electronic storage component of the module, and to communicate the determined output to other devices connected to the one or more communications media;
at least one parent module possessing a parent module processor configured to aggregate output from the interface modules, and to send input events to the electronic computing device that are based on the determined outputs of the interface modules.

21. The ergonomic input device of claim 20, where the structural arrangement of one or more of said interface modules are based on the shape described by the path an operator's limb, digit, extremity or other contact surface will follow when moved between two points inside the total range of motion for said limb, digit, extremity or contact surface.

22. The device of claim 20, where two or more subsets of said input sensors are physically adjacent to each other, but differ in position or orientation, and at least one interface module is used for connecting to each subset of adjacent input sensors that share similar orientations or positional relationships.

23. The device of claim 20, where multiple input sensors are to be placed contiguously, with subset A of one type of input sensor and subset B of a different type of input sensors, and one or more interface modules are used to connect the like sensors of subset A or of Subset B.

24. The device of claim 20, where the structural arrangement of each interface module is further chosen to permit interconnection with adjacent modules.

25. The device of claim 20, where the structural arrangement of each interface module is further chosen to permit interconnection with adjacent modules.

26. The device of claim 25, where the structural arrangement of each interface module is further chosen to permit interconnection with adjacent modules.

27. The device of claim 20, wherein each of the one or more input sensors is configured to generate an on-off, binary output.

28. The device of claim 20, wherein at least one of the three or more interface modules is employed for each contact surface of the operator that is used for operator input.

29. The device of claim 20, wherein one or more discrete interface modules are employed for each of at least 40% of the contact surfaces of the operator that are used for operator input.

30. The device of claim 20, wherein the one or more input sensors include an input sensor configured to generate an output with a range of values.
